(19) United States
(12) Patent Application Publication
(10) Pub. No.: US 2026/0279842 A1
(43) Pub. Date: Sep. 17, 2026

(54) CATALYST LAYER

(71) Applicant: TOYOTA JIDOSHA KABUSHIKI KAISHA, Toyota-shi (JP)

(72) Inventors: Kohei INAGAWA, Toyota-shi (JP); Keiichi OKUBO, Toyota-shi (JP)

(73) Assignee: TOYOTA JIDOSHA KABUSHIKI KAISHA, Toyota-shi (JP)

(21) Appl. No.: 19/531,899

(22) Filed: Feb. 6, 2026

(30) Foreign Application Priority Data
Mar. 11, 2025 (JP) 2025-038687

(51) Int. Cl. H01M 4/90; C25B 9/23; C25B 11/065; C25B 11/081; H01M 8/10; H01M 8/1004; H01M 8/1039

(52) U.S. Cl. CPC H01M 4/9083; C25B 9/23; C25B 11/065; C25B 11/081; H01M 8/1004; H01M 8/1039; H01M 2008/1095

(57) ABSTRACT

A catalyst layer includes carbon support particles, metal particles supported on the carbon support particles and having oxygen reduction activity, an organic nitrogen compound, a first ionomer, and a second ionomer. The first ionomer is a perfluorosulfonic acid polymer without a cyclic structure. The second ionomer is a perfluorosulfonic acid polymer with a cyclic structure. A content of the first ionomer is 12.5 wt % to 20 wt % with respect to a total mass of the first ionomer and the second ionomer.

### CROSS-REFERENCE TO RELATED APPLICATION

This application claims priority to Japanese Patent Application No. 2025-038687 filed on Mar. 11, 2025. The disclosure of the above-identified application, including the specification, drawings, and claims, is incorporated by reference herein in its entirety.

### BACKGROUND

### 1. Technical Field

The present disclosure relates to a catalyst layer.

### 2. Description of Related Art

Various studies have been conducted on electrochemical oxygen reduction catalysts.

Japanese Patent No. 7089805 (JP 7089805 B) discloses an electrochemical oxygen reduction catalyst containing platinum-containing nanoparticles and at least one selected from the group consisting of a melamine compound, a thiocyanuric acid compound, and a polymer having the melamine compound or the thiocyanuric acid compound as a monomer, and describes that this catalyst has high oxygen reduction activity.

Japanese Unexamined Patent Application Publication No. 2023-131046 (JP 2023-131046 A) describes a catalyst layer having the following configurations (1) to (4). (1) The catalyst layer includes an ionomer/catalyst composite and an ionomer/substrate composite. (2) The ionomer/catalyst composite includes an electrode catalyst in which catalyst particles are supported on the surfaces of conductive particles, and a first ionomer that coats at least the surfaces of the conductive particles. (3) The ionomer/substrate composite includes sheet-shaped substrate particles and a second ionomer that coats the surfaces of the substrate particles. (4) The ion exchange capacity of the first ionomer is smaller than the ion exchange capacity of the second ionomer. As materials for the first ionomer, perfluorocarbon sulfonic acid polymers and highly oxygen-permeable ionomers are described, and the highly oxygen-permeable ionomers are described as polymer compounds containing acid groups and cyclic structures within their molecular structure.

Ryosuke Jinnouchi et al., “The role of oxygen-permeable ionomer for polymer electrolyte fuel cells,” Nature Communications, volume 12, Article number 4956, 2021 reports effects of incorporating a cyclic structured skeletal matrix into an ionomer of a cathode catalyst layer of a fuel cell.

### SUMMARY

Organic nitrogen compounds such as melamine compounds and thiocyanuric acid compounds improve the performance of catalysts having oxygen reduction activity. The present inventors have found that, in a catalyst layer containing metal particles that are catalysts having oxygen reduction activity, an organic nitrogen compound, and an ionomer, a perfluorosulfonic acid polymer without a cyclic structure and a perfluorosulfonic acid polymer with a cyclic structure are used as the ionomer at an appropriate ratio, whereby the catalytic performance improving effect of the organic nitrogen compound can be exerted sufficiently. Therefore, the present disclosure provides a catalyst layer that can sufficiently exert the catalytic performance improving effect of an organic nitrogen compound.

Aspects of the present disclosure include the following.

### First Aspect

A catalyst layer including:
carbon support particles;
metal particles supported on the carbon support particles and having oxygen reduction activity;
an organic nitrogen compound;
a first ionomer; and
a second ionomer, in which
the first ionomer is a perfluorosulfonic acid polymer without a cyclic structure,
the second ionomer is a perfluorosulfonic acid polymer with a cyclic structure, and
a content of the first ionomer is 12.5 wt % to 20 wt % with respect to a total mass of the first ionomer and the second ionomer.

### Second Aspect

The catalyst layer according to the first aspect, in which:
a mass ratio of the content of the first ionomer to a content of the carbon support particles (content of first ionomer/content of carbon support particles) is 0.1 to 0.2; and
a mass ratio of a content of the second ionomer to the content of the carbon support particles (content of second ionomer/content of carbon support particles) is 0.7 to 0.9.

### Third Aspect

The catalyst layer according to the first or second aspect, in which:
the perfluorosulfonic acid polymer without the cyclic structure is at least one polymer containing at least one repeating unit having a sulfonic acid group; and
the perfluorosulfonic acid polymer with the cyclic structure is
   (a) at least one polymer containing at least one repeating unit having a sulfonic acid group and at least one repeating unit having a cyclic structure,
   (b) at least one polymer containing at least one repeating unit having a cyclic structure with an acid group in a side chain, or
   a mixture of the (a) and the (b).

### Fourth Aspect

The catalyst layer according to any one of the first to third aspects, in which a mass ratio of a content of the organic nitrogen compound to a content of the carbon support particles (content of organic nitrogen compound/content of carbon support particles) is 0.01 to 0.05.

### Fifth Aspect

The catalyst layer according to any one of the first to fourth aspects, in which the organic nitrogen compound is melamine, a cation of the melamine, or a polymer containing a constitutional unit derived from polymerization of the melamine.

With the catalyst layer of the present disclosure, the catalytic performance improving effect of the organic nitrogen compound is exerted sufficiently.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing the relationship between a first ionomer content with respect to the total ionomer mass and a cell voltage improvement amount.

### DETAILED DESCRIPTION OF EMBODIMENTS

Hereinafter, embodiments will be described with reference to the drawings as appropriate, but the present disclosure is not limited to the following embodiments. Various modifications, changes, additions, omissions, and/or combinations of the following embodiments are possible without departing from the technical scope described in the claims.

In the present application, a numerical range expressed using “to” includes the values before and after “to” as the lower limit and the upper limit, respectively, unless otherwise specified. The upper and lower limits described in the present application can be used alone or in any combination.

In the present application, unless otherwise specified, the terms “include” and “contain” mean that additional components or elements may be included, and encompass the terms “consist essentially of” and “consist of.” The term “consist essentially of” means that additional components or elements may be included without substantial adverse effects. The term “consist of” means that only the listed materials or elements are included but further inclusion of unavoidable impurities is not excluded.

### 1. Catalyst Layer

A catalyst layer according to an embodiment includes carbon support particles, metal particles supported on the carbon support particles and having oxygen reduction activity, an organic nitrogen compound, a first ionomer, and a second ionomer. These components are mixed in the catalyst layer.

The carbon support particles (hereinafter sometimes simply referred to as “support particles”) may be particles of carbon black (e.g., acetylene black, ketjen black, or furnace black), activated carbon, graphite, glassy carbon, graphene, carbon fibers, carbon nanotubes, carbon nitride, carbon sulfide, carbon phosphide, or a mixture containing at least two of these carbon materials. The carbon support particles may be primary particles or secondary particles. The support particles may have an average particle size of 30 nm to 1000 nm. In the present application, the average particle size of the support particles is an average value of the equivalent circle diameters of 100 to 1000 support particles randomly selected in an electron microscope image.

The metal particles having oxygen reduction activity may be platinum-containing particles, and may be, for example, at least one selected from the group consisting of platinum particles, platinum alloy particles, and composite particles containing platinum. Examples of the platinum alloys include alloys of platinum with at least one metal selected from the group consisting of ruthenium, iridium, rhodium, palladium, osmium, tungsten, lead, iron, chromium, cobalt, nickel, manganese, vanadium, molybdenum, gallium, aluminum, lanthanum, cerium, gadolinium, yttrium, zirconium, titanium, copper, silver, gold, and alloys thereof. The elemental ratio of the metal other than platinum in the platinum alloy may be, for example, 0.11 atm % to 50 atm %. The platinum-containing particles may have an average particle size of 1 nm to 1000 nm. In the present application, the average particle size of the platinum-containing particles is an average crystallite size measured by X-ray diffraction.

The metal support ratio of the metal particles is not particularly limited, and may be 1 wt % to 60 wt %, or 18 wt % to 48 wt %. In the present application, the metal support ratio means the mass of the metal particles with respect to the total mass of the support particles and the metal particles.

The method for supporting the metal particles on the support particles is not particularly limited, and any known method can be adopted as appropriate.

The organic nitrogen compound may be at least one selected from the group consisting of a monomer represented by formula (1), a cation thereof, and a polymer containing a constitutional unit derived from polymerization thereof:

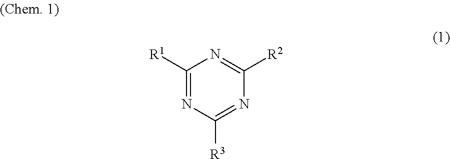

(where R¹, R², and R³ are each independently selected from the group consisting of a hydrogen atom, a halogen atom, a nitrile group, an amide group, an imine group, an amino group, a thiol group, a hydroxyl group, a sulfo group, a carboxylic acid group, a phosphate group, a ketone group, an aldehyde group, an ester group, an alkoxy group, a phenol group, a cyclopentyl group, a cyclohexyl group, an alkylamino group having a carbon number of 1 to 10, an alkylsulfonic acid group having a carbon number of 1 to 10, a perfluoroalkyl group having a carbon number of 1 to 10, an alkyl group having a carbon number of 1 to 10, an alkenylamino group having a carbon number of 1 to 10, an alkenylsulfonic acid group having a carbon number of 1 to 10, a perfluoroalkenyl group having a carbon number of 1 to 10, and an alkenyl group having a carbon number of 1 to 10, and these groups may be substituted with at least one selected from the group consisting of a nitrile group, an amide group, an imine group, an amino group, a thiol group, a hydroxyl group, a sulfo group, a carboxylic acid group, a phosphate group, a ketone group, an aldehyde group, an ester group, an alkoxy group, a phenol group, a cyclopentyl group, a cyclohexyl group, an alkylamino group having a carbon number of 1 to 10, an alkylsulfonic acid group having a carbon number of 1 to 10, a perfluoroalkyl group having a carbon number of 1 to 10, an alkyl group having a carbon number of 1 to 10, an alkenylamino group having a carbon number of 1 to 10, an alkenylsulfonic acid group having a carbon number of 1 to 10, a perfluoroalkenyl group having a carbon number of 1 to 10, an alkenyl group having a carbon number of 1 to 10, an aromatic ring, a heterocycle, an oxygen atom, a sulfur atom, a nitrogen atom, a fluorine atom, a chlorine atom, a bromine atom, and an iodine atom).

In formula (1), R¹, R², and R³ may each independently represent a primary amine, a secondary amine, a tertiary amine, or a quaternary ammonium cation.

The organic nitrogen compound may have a nitrogen equivalent weight of 20 g·eq⁻¹ to 270 g·eq⁻¹ or 20 g eq⁻¹ to 70 g·eq⁻¹. The nitrogen equivalent weight represents a dry weight per mole of nitrogen and can be calculated from the following formula. When the organic nitrogen compound is a polymer, the nitrogen equivalent weight of the monomer of the polymer is regarded as the nitrogen equivalent weight of the organic nitrogen compound.

Nitrogen equivalent weight (g·eq⁻¹)=molecular weight of organic nitrogen compound (g/mol)÷amount of nitrogen substance in organic nitrogen compound (mol_{N}/mol)

The organic nitrogen compound may have an amine functional group, pyridine nitrogen, or a triazine ring.

Examples of the organic nitrogen compound include a melamine compound (nitrogen equivalent weight of 21 g·eq⁻¹), a thiocyanuric acid compound (nitrogen equivalent weight of 59 g·eq⁻¹), a cyanuric acid compound (nitrogen equivalent weight of 34 g·eq⁻¹), oleylamine (nitrogen equivalent weight of 267 g·eq⁻¹), tetradecylamine (nitrogen equivalent weight of 213 g·eq⁻¹), 2,4,6-tris [bis(methoxymethyl)amino]-1,3,5-triazine (nitrogen equivalent weight of 65 g·eq⁻¹), 6-(dibutylamino)-1,3,5-triazine-2,4-dithiol (nitrogen equivalent weight of 68 g·eq⁻¹), 2,4-diamino-6-butylamino-1,3,5-triazine (nitrogen equivalent weight of 30 g·eq⁻¹), 2,4,6-tris(pentafluoroethyl)-1,3,5-triazine (nitrogen equivalent weight of 145 g eq⁻¹), cations of these compounds, polymers containing constitutional units derived from polymerization of these compounds, a poly(melamine-co-formaldehyde)methylated product (nitrogen equivalent weight of 20 g·eq⁻¹ to 40 g·eq⁻¹), and a poly(melamine-co-formaldehyde) isobutylated product (nitrogen equivalent weight of 20 g·eq 1 to 40 g·eq⁻¹).

Examples of the melamine compound include 1,3,5-triazine-2,4,6-triamine (melamine) and derivatives thereof. Examples of the thiocyanuric acid compound include thiocyanuric acid and derivatives thereof. Examples of the cyanuric acid compound include cyanuric acid and derivatives thereof.

The organic nitrogen compound may have a degree of polymerization in a range of 1 to 10000.

The mass ratio of the content of the organic nitrogen compound to the content of the carbon support particles in the catalyst layer (content of organic nitrogen compound/content of carbon support particles) may be 0.01 to 0.05. Thus, it is possible to sufficiently improve the catalytic performance of the metal particles.

The first ionomer is a perfluorosulfonic acid polymer without a cyclic structure. The perfluorosulfonic acid polymer without the cyclic structure may be at least one polymer containing at least one repeating unit having a sulfonic acid group (e.g., a linear or branched perfluoroalkylene group that is substituted with a sulfonic acid group and may have an ether-bonding oxygen atom). Examples of the perfluorosulfonic acid polymer without the cyclic structure include Nafion (registered trademark), Flemion (registered trademark), and Aquivion (registered trademark).

The second ionomer is a perfluorosulfonic acid polymer with a cyclic structure. The perfluorosulfonic acid polymer with the cyclic structure may be (a) at least one polymer containing at least one repeating unit having a sulfonic acid group (e.g., a linear or branched perfluoroalkylene group that is substituted with a sulfonic acid group and may have an ether-bonding oxygen atom) and at least one repeating unit having a cyclic structure, (b) at least one polymer containing at least one repeating unit having a cyclic structure with an acid group (e.g., a sulfonic acid group, a carboxylic acid group, a phosphoric acid group) in the side chain, or a mixture of (a) and (b). The cyclic structure may be a carbocyclic or heterocyclic ring, an alicyclic or aromatic ring, and may be a monocyclic ring or a polycyclic ring containing two or more rings. The cyclic structure may be an alicyclic ring, preferably a heteroalicyclic ring, more preferably a heteroalicyclic ring having an ether-bonding oxygen atom. Examples of the repeating unit having the cyclic structure include a repeating unit represented by formula (2):

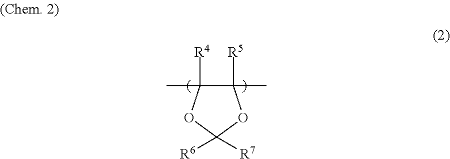

(where R⁴ and R⁵ each independently represent a fluorine atom or a linear or branched perfluoroalkyl group that may have an ether-bonding oxygen atom, R⁶ and R⁷ each independently represent a fluorine atom, a linear or branched perfluoroalkyl group that may have an ether-bonding oxygen atom, or a group represented by —R⁸SO₂X(SO₂R^{f})ₐ⁻M⁺, R⁸ represents a linear or branched perfluoroalkylene group that may have an ether-bonding oxygen atom, X represents an oxygen atom, a nitrogen atom, or a carbon atom, a=0 when X is an oxygen atom, a=1 when X is a nitrogen atom, and a=2 when X is a carbon atom, R^{f} represents a linear or branched perfluoroalkyl group that may have an ether-bonding oxygen atom, and M⁺ represents H⁺, a monovalent metal cation (e.g., potassium ion or sodium ion), or an ammonium ion that may be substituted with a hydrocarbon group (e.g., methyl group or ethyl group)).

More specific examples of the repeating unit having the cyclic structure include a repeating unit represented by formula (3):

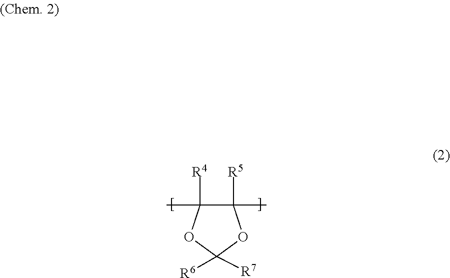

and a repeating unit represented by formula (4):

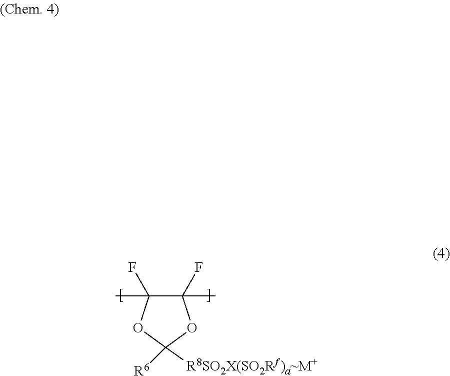

(where R⁶, R⁸, X, R^{f}, M⁺, and “a” are as defined in formula (2)).

The content of the first ionomer is 12.5 wt % to 20 wt % with respect to the total mass of the first ionomer and the second ionomer. Thus, the catalytic performance improving effect of the organic nitrogen compound can be exerted sufficiently. Without limitation by any theory, the present inventors believe that the reason for this is as follows.

The first ionomer serves to disperse the metal particles and the support particles satisfactorily in catalyst ink for forming the catalyst layer. However, the sulfonic acid group (SO₃H) contained in the first ionomer tends to preferentially adsorb to the metal particles, causing difficulty in adsorption of the organic nitrogen compound to the metal particles. The second ionomer contains the cyclic structure in its skeleton, thereby limiting the mobility of the sulfonic acid group contained in the second ionomer. Thus, the sulfonic acid group contained in the second ionomer hardly adsorbs to the metal particles. Since the content of the first ionomer is 12.5 wt % or more, the metal particles and the support particles can be dispersed satisfactorily in the catalyst ink. Since the content of the first ionomer is 20 wt % or less, the adsorption of the sulfonic acid group in the ionomer to the metal particles can be reduced sufficiently. Therefore, when the content of the first ionomer is 12.5 wt % to 20 wt % with respect to the total mass of the first ionomer and the second ionomer, the metal particles are dispersed satisfactorily in the catalyst ink and the adsorption of the sulfonic acid group to the metal particles is suppressed, thereby allowing the organic nitrogen compound to sufficiently adsorb to the metal particles. Thus, the catalytic performance improving effect of the organic nitrogen compound is exerted sufficiently.

The mass ratio of the content of the first ionomer to the content of the carbon support particles (content of first ionomer/content of carbon support particles) may be 0.1 to 0.2, and the mass ratio of the content of the second ionomer to the content of the carbon support particles (content of second ionomer/content of carbon support particles) may be 0.7 to 0.9. Thus, the catalyst layer can exhibit sufficient oxygen reduction activity.

The contents of the metal particles, the support particles, the first ionomer, and the second ionomer in the catalyst layer can be determined by thermogravimetric analysis (TG) or inductively coupled plasma emission spectroscopy (ICP). The content of the organic nitrogen compound in the catalyst layer can be determined by a method of measuring the nitrogen content by CHN elemental analysis, or by a method of extracting the organic nitrogen compound from the catalyst layer and quantifying it by chromatography, ultraviolet-visible spectroscopy (UV-vis), infrared spectroscopy (IR), or nuclear magnetic resonance (NMR).

The catalyst layer according to the embodiment may be used for a fuel cell or a metal-air battery. The catalyst layer according to the embodiment can be used in a cathode or anode of the fuel cell, or an air electrode of the metal-air battery. The catalyst layer according to the embodiment may be used in an anode or cathode for water electrolysis, or an anode or cathode for CO₂ reduction. A membrane electrode assembly may be produced by sandwiching an electrolyte membrane between two catalyst layers and bonding them under pressure. The electrolyte membrane may be any electrolyte membrane. The bonding under pressure may be thermocompression bonding. The temperature and pressure of the thermocompression bonding can be set as appropriate.

### 2. Method for Producing Catalyst Layer

An example of a method for producing the catalyst layer according to the embodiment will be described.

### (a) Preparation of Catalyst Ink

Support particles that support metal particles and a solvent are mixed using a stirrer. The solvent is not particularly limited, and may be, for example, water, an alcohol, or a mixture of at least one alcohol and water. Examples of the alcohol include methanol, diacetone alcohol, ethanol, 1-propanol, 2-propanol, tert-butyl alcohol, ethylene glycol, and propylene glycol. Examples of the stirrer include an ultrasonic homogenizer, a jet mill, a ball mill such as a bead mill, a high-shear mill, and a Filmix. The stirring conditions (e.g., stirring speed, stirring time, and rotation speed) can be set as appropriate.

An organic nitrogen compound is added to the mixture of the support particles that support the metal particles and the solvent, and is mixed by stirring. Examples of the stirrer are the same as those described above. The stirring conditions can be set as appropriate. After the stirring, the obtained mixture may be degassed under vacuum and left to stand. The time for leaving the mixture to stand can be set as appropriate, and the mixture may be left to stand, for example, for one day. The subsequent steps may be performed without leaving the mixture to stand. After leaving the mixture to stand, vacuum degassing may be performed again.

A first ionomer is then added to the obtained mixture, and is mixed by stirring. Examples of the stirrer are the same as those described above. The stirring conditions can be set as appropriate.

A second ionomer is further added to the obtained mixture, and is mixed by stirring. Thus, catalyst ink is obtained. Examples of the stirrer are the same as those described above. The stirring conditions can be set as appropriate. After the stirring, the obtained mixture may be degassed under vacuum and left to stand. The time for leaving the mixture to stand can be set as appropriate, and the mixture may be left to stand, for example, for one day. The subsequent steps may be performed without leaving the mixture to stand. After leaving the mixture to stand, vacuum degassing may be performed again.

### (b) Application of Catalyst Ink

The prepared catalyst ink is applied onto a substrate to form a catalyst ink layer. Examples of the substrate to be used include polytetrafluoroethylene (PTFE), an electrolyte membrane having an ion exchange group, and a gas diffusion layer (GDL) (e.g., a GDL made of carbon fibers or metal fibers, or a GDL made of carbon fibers or metal fibers with a microporous layer (MPL)). The application can be performed by any method that allows the catalyst ink to be applied uniformly onto the substrate. Examples of the application method include die coating, spin coating, screen printing, doctor blade coating, squeegee coating, spray coating, and applicator coating.

The catalyst ink layer is heated to dry and remove the solvent in the catalyst ink layer. Thus, a catalyst layer is formed. The heating rate and the heating time can be set as appropriate depending on the type of the solvent, etc. The rate of solvent removal may be increased by degassing during the heating. The thickness of the catalyst layer may be 5 μm to 30 μm. The catalyst ink may be applied such that the amount of the metal catalyst per unit area is 0.1 mg cm⁻² to 0.6 mg·cm⁻².

The present disclosure will be described in more detail below with reference to Examples. However, the scope of the present disclosure is not limited to Examples.

### 1. Materials

Metal particles (cathode catalyst): platinum-cobalt alloy particles (particle size: 3 nm to 4 nm)
Organic nitrogen compound: melamine (produced by Fujifilm Wako Pure Chemical Industries, Ltd.)
First ionomer: Nafion (registered trademark)
Second ionomer: perfluorosulfonic acid polymer having the following structure as shown in FIG. 2c of Ryosuke Jinnouchi et al., “The role of oxygen-permeable ionomer for polymer electrolyte fuel cells,” Nature Communications, volume 12, Article number 4956, 2021:

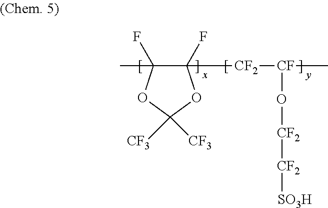

Solvent: mixture of water and alcohol
Electrolyte membrane: perfluorosulfonic acid polymer

### 2. Production of Catalyst Layer

Carbon support particles that support metal particles (metal support ratio of 48 wt %), a solvent, an organic nitrogen compound, and a first ionomer were placed in a container in this order, and stirred for 20 minutes with an ultrasonic homogenizer. Next, a second ionomer was added to the container and stirred with a Filmix at a peripheral speed of 30 m/sec for 180 seconds. Thus, catalyst ink was prepared.

The catalyst ink was degassed under vacuum and left to stand for one day. Then, the catalyst ink was degassed under vacuum again. The catalyst ink was applied onto a polytetrafluoroethylene (PTFE) substrate by die coating to form a catalyst ink layer. The catalyst ink layer was heated to dry and remove the solvent, thereby forming a catalyst layer. The platinum content in the catalyst layer was 0.20 mg cm⁻². In the catalyst layer, the mass ratio of the content of the organic nitrogen compound to the content of the carbon support particles (represented as “organic nitrogen compound/support particles” in Table 1), the mass ratio of the content of the first ionomer to the content of the carbon support particles (represented as “first ionomer/support particles” in Table 1), the mass ratio of the content of the second ionomer to the content of the carbon support particles (represented as “second ionomer/support particles” in Table 1), and the content (wt %) of the first ionomer with respect to the total mass of the first ionomer and the second ionomer (total ionomer mass) were as shown in Table 1.

### 3. Production of Membrane Electrode Assembly

An anode catalyst layer containing an acetylene black support that supported platinum was formed on another PTFE substrate. Catalyst layers of Examples 1 to 8 and Comparative Examples 1 to 9 were used as cathode catalyst layers. An electrolyte membrane was sandwiched between the cathode catalyst layer and the anode catalyst layer, and the cathode catalyst layer, the electrolyte membrane, and the anode catalyst layer were subjected to thermocompression bonding at a temperature of 145° C. and a pressure of 4 MPa. Gas diffusion layers made of carbon fibers (GDL 22 BB produced by SGL Carbon) were placed on both sides of the obtained thermocompression bonded body to obtain a membrane electrode assembly (electrode area of 1 cm²).

### 4. Cell Evaluation

Under a highly humidified condition (80% RH), the current-voltage characteristics of the membrane electrode assembly were evaluated at a sweep rate of 20 mA/s by anodic sweep. The other conditions were as follows:
Cell temperature: 80° C.
Pressure: 150 kPa (abs)
Cathode gas: air
Cathode gas flow rate: 2.0 L/min
Anode gas: hydrogen
Anode gas flow rate: 1.0 L/min

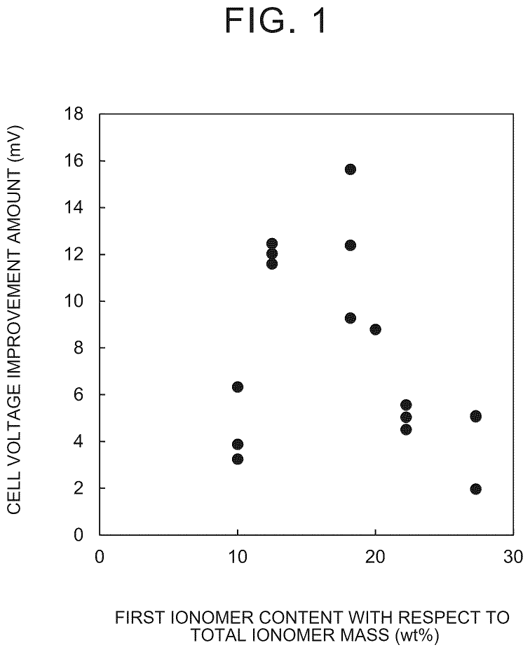

A membrane electrode assembly was produced in the same manner as in Examples 1 to 8 and Comparative Examples 1 to 9, except that no organic nitrogen compound was added, and the current-voltage characteristics were evaluated. The current-voltage characteristics of Examples 1 to 8 and Comparative Examples 1 to 9 were compared to the current-voltage characteristics in the case where no organic nitrogen compound was added, and the cell voltage improvement amount (mV) due to the addition of the organic nitrogen compound was calculated. The results are shown in Table 1. FIG. 1 is a graph in which the cell voltage improvement amount is plotted relative to the first ionomer content with respect to the total ionomer mass.

As can be seen from Table 1 and FIG. 1, when the content of the first ionomer was in the range of 12.5 wt % to 20 wt % with respect to the total mass of the first ionomer and the second ionomer, the cell voltage improvement amount was large and excellent power generation performance was exhibited. That is, the effect obtained by the addition of the organic nitrogen compound was great in the above range.

When the content of the first ionomer was less than 12.5 wt %, the carbon support particles that supported the metal particles were not dispersed sufficiently in the catalyst ink, and the adsorption of the organic nitrogen compound to the metal particles was insufficient. Therefore, it is thought that the catalytic performance improving effect of the organic nitrogen compound was not exerted sufficiently. When the content of the first ionomer was more than 20 wt %, the sulfonic acid group in the first ionomer preferentially adsorbed to the metal particles, and the organic nitrogen compound did not sufficiently adsorb to the metal particles. Therefore, it is thought that the catalytic performance improving effect of the organic nitrogen compound was not exerted sufficiently.

TABLE 1

| | | | | First | |
|---|---|---|---|---|---|
| | Organic | | | ionomer | |
| | nitrogen | First | Second | content with | Cell |
| | compound / | ionomer / | ionomer / | respect to | voltage |
| | support | support | support | total | improvement |
| | particles | particles | particles | ionomer | amount |
| | (w/w) | (w/w) | (w/w) | mass (wt %) | (mV) |
| Example 1 | 0.01 | 0.1 | 0.7 | 12.5 | 11.6 |
| Example 2 | 0.03 | 0.1 | 0.7 | 12.5 | 12.5 |
| Example 3 | 0.05 | 0.1 | 0.7 | 12.5 | 12.0 |
| Example 4 | 0.01 | 0.2 | 0.9 | 18.2 | 9.3 |
| Example 5 | 0.03 | 0.2 | 0.9 | 18.2 | 12.4 |
| Example 6 | 0.05 | 0.2 | 0.9 | 18.2 | 15.6 |
| Example 7 | 0.03 | 0.2 | 0.8 | 20.0 | 8.8 |
| Example 8 | 0.05 | 0.2 | 0.8 | 20.0 | 8.8 |
| Comparative | 0.01 | 0.1 | 0.9 | 10.0 | 3.9 |
| Example 1 | | | | | |
| Comparative | 0.03 | 0.1 | 0.9 | 10.0 | 6.3 |
| Example 2 | | | | | |
| Comparative | 0.05 | 0.1 | 0.9 | 10.0 | 3.3 |
| Example 3 | | | | | |
| Comparative | 0.01 | 0.2 | 0.7 | 22.2 | 5.0 |
| Example 4 | | | | | |
| Comparative | 0.03 | 0.2 | 0.7 | 22.2 | 5.6 |
| Example 5 | | | | | |
| Comparative | 0.05 | 0.2 | 0.7 | 22.2 | 4.5 |
| Example 6 | | | | | |
| Comparative | 0.01 | 0.3 | 0.8 | 27.3 | 2.0 |
| Example 7 | | | | | |
| Comparative | 0.03 | 0.3 | 0.8 | 27.3 | 5.1 |
| Example 8 | | | | | |
| Comparative | 0.05 | 0.3 | 0.8 | 27.3 | 5.1 |
| Example 9 | | | | | |

What is claimed is:

1. A catalyst layer comprising:
carbon support particles;
metal particles supported on the carbon support particles and having oxygen reduction activity;
an organic nitrogen compound;
a first ionomer; and
a second ionomer, wherein
the first ionomer is a perfluorosulfonic acid polymer without a cyclic structure,
the second ionomer is a perfluorosulfonic acid polymer with a cyclic structure, and
a content of the first ionomer is 12.5 wt % to 20 wt % with respect to a total mass of the first ionomer and the second ionomer.

2. The catalyst layer according to claim 1, wherein:
a mass ratio of the content of the first ionomer to a content of the carbon support particles (content of first ionomer/content of carbon support particles) is 0.1 to 0.2; and
a mass ratio of a content of the second ionomer to the content of the carbon support particles (content of second ionomer/content of carbon support particles) is 0.7 to 0.9.

3. The catalyst layer according to claim 1, wherein:
the perfluorosulfonic acid polymer without the cyclic structure is at least one polymer containing at least one repeating unit having a sulfonic acid group; and
the perfluorosulfonic acid polymer with the cyclic structure is
(a) at least one polymer containing at least one repeating unit having a sulfonic acid group and at least one repeating unit having a cyclic structure,
(b) at least one polymer containing at least one repeating unit having a cyclic structure with an acid group in a side chain, or
a mixture of the (a) and the (b).

4. The catalyst layer according to claim 1, wherein a mass ratio of a content of the organic nitrogen compound to a content of the carbon support particles (content of organic nitrogen compound/content of carbon support particles) is 0.01 to 0.05.

5. The catalyst layer according to claim 1, wherein the organic nitrogen compound is melamine, a cation of the melamine, or a polymer containing a constitutional unit derived from polymerization of the melamine.
